(19) United States
(12) Patent Application Publication
(10) Pub. No.: US 2018/0260262 A1
(43) Pub. Date: Sep. 13, 2018

(54) AVAILABILITY MANAGEMENT INTERFACES IN A DISTRIBUTED COMPUTING SYSTEM

(71) Applicant: MICROSOFT TECHNOLOGY LICENSING, LLC, Redmond, WA (US)

(72) Inventors: YUNUS MOHAMMED, Bellevue, WA (US); JUN WANG, Sammamish, WA (US); MARCUS FELIPE FONTOURA, Clyde Hill, WA (US); MARK EUGENE RUSSINOVICH, Hunts Point, WA (US); MOHAMMAD ZEESHAN SIDDIQUI, Bellevue, WA (US); PRITESH PATWA, Redmond, WA (US); SEAN DAVID ZIMMERMAN, Seattle, WA (US); XIAOXIONG TIAN, Kirkland, WA (US)

(21) Appl. No.: 15/452,661

(22) Filed: Mar. 7, 2017

(51) Int. Cl. G06F 11/00; H04L 12/24; G06F 9/455

(52) U.S. Cl. CPC G06F 11/008; H04L 41/0654; G06F 2009/4557; G06F 9/45558; G06F 2009/45591; G06F 11/004

(57) ABSTRACT

Various methods and systems for implementing an availability management system for implementing an availability management, in distributed computing systems, are provided. An availability management system implements an availability manager and an availability configuration interface to meet availability guarantees for tenant infrastructure. The availability management systems operates with availability zones, computing clusters, fault and upgrade domains to allocate and de-allocate virtual machine sets of virtual machine instances to a distributed computing system based on tenant-defined availability parameters. The availability configuration interface of the availability management system supports receiving availability parameters that are used to generate an availability profile. The availability profile comprises availability parameters including, configurations for spanning or non-spanning, rebalancing, fault domains, update domains, and availability zones associated with allocating a virtual machine sets. The availability zones are exposed to the tenant as logically-defined availability zones that map to physically-defined availability zones for an abstracted implementation of the availability zones.

### BACKGROUND

Distributed computing systems or cloud computing platforms are computing infrastructures that support network access to a shared pool of configurable computing and storage resources. A distributed computing system can support building, deploying and managing application and services. An increasing number of users and enterprises are moving away from traditional computing infrastructures to run their applications and services on distributed computing systems. As such, distributed computing system providers are faced with the challenge of supporting the increasing number of users and enterprises sharing the same distributed computing system resources. In particular, distributed computing system providers are designing infrastructures and systems to support maintaining high availability and disaster recovery for resources in their distributed computing systems.

Conventional distributed computing systems struggle with supporting availability for large scale deployments of virtual machines. Distributed computing system providers can provide guarantees for availability but currently have limited configuration options to efficiently meet the availability guarantees to customer. Several different considerations have to be made, such as, how to place replica virtual machines to avoid data loss, how to guarantee a minimum number of active service virtual machines, understanding different types of failures and their impact on applications and services running on their distributed computing systems. As such, a comprehensive availability management system can be implemented to improve customer availability offerings and configurations for availability management in distributed computing systems.

### SUMMARY

Embodiments described herein are directed to methods, systems and computer storage media for availability management in distributed computing systems. An availability management system supports customizable, hierarchical and flexible availability configurations to maximize utilization of computing resources in a distributed computing system to meet availability guarantees for tenant infrastructure (e.g., customer virtual machine sets). An availability management system includes a plurality of availability zones within a region. An availability zone is a defined zone-tier isolated point of failure for a computing construct with a low-latency connection to other availability zones. The availability management system also includes a plurality of computing clusters defined within availability zones. The availability management system instantiates a plurality of cluster-tenants associated with the plurality of computing clusters, where a cluster-tenant is a defined instance of a portion of a computing cluster. The cluster-tenants are allocated to virtual machine sets for availability isolation tiers (e.g., a fault-tier or update-tier) that define isolated points of failures for computing constructs. Virtual machine sets having a plurality of virtual machines instances are allocated to cluster-tenants across availability zones or within a single availability zone based on tenant-defined availability parameters for availability.

In operation, an availability configuration interface of the availability management system supports receiving availability parameters that are used to generate an availability profile. The availability profile comprises availability parameters (e.g., spanning multiple availability zones or non-spanning—limited to a single availability zone, rebalancing, number of fault domains, update domains, availability zones, etc.) associated with allocating (and de-allocating) a virtual machine set of the tenant to the plurality of availability zones.

The availability management system also includes an availability manager. An availability manager is configured to: based on an availability profile, allocate the virtual machine sets across the plurality of availability zones, using an allocation scheme. The allocation scheme may be a virtual machine set spanning availability zones allocation scheme for performing evaluations to determine an allocation configuration—an arrangement of virtual machine instances—defined across at least two availability zones for allocating virtual machine sets. When the allocation configuration meets the availability parameters of the availability profile, the allocation scheme selects the allocation configuration for allocating the virtual machine set. The allocation scheme can alternatively be a virtual machine set non-spanning availability zones allocation scheme for performing evaluations for determining an allocation configuration defined for only a single availability zone and within a computing cluster for allocating the virtual machine set. When the allocation configuration meets the availability parameters of the availability profile, the allocation scheme selects the allocation configuration for allocating the virtual machine set. The allocation configurations in both cases can be defined based on cluster-tenants of computing clusters. Advantageously, the availability management system also supports scaling-out, scaling-in and rebalancing operations for allocating, de-allocating, and relocating virtual machine instances of virtual machine sets to computing clusters across availability zones while maintaining availability service level agreements or guarantees and providing customizable, hierarchical and flexible availability configurations.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary distributed computing system and availability management system, in accordance with embodiments described herein;

FIG. 2 is a block diagram of an exemplary distributed computing system and availability management system, in accordance with embodiments described herein;

FIGS. 3A and 3B illustrate exemplary scaling-out operation outcomes using the availability management system, in accordance with embodiments described herein;

FIGS. 4A and 4B illustrate exemplary scaling-in operation outcomes using the availability management system, in accordance with embodiments described herein;

FIG. 5 is a flow diagram showing an exemplary method for providing an availability management system, in accordance with embodiments described herein;

FIG. 6 is a flow diagram showing an exemplary method for providing an availability management system, in accordance with embodiments described herein;

FIG. 7 is a flow diagram showing an exemplary method for providing an availability management system, in accordance with embodiments described herein;

FIG. 8 is a flow diagram showing an exemplary method for providing an availability management system, in accordance with embodiments described herein;

FIG. 9 is a flow diagram showing an exemplary method for providing an availability management system, in accordance with embodiments described herein;

FIG. 10 is a flow diagram showing an exemplary method for providing an availability management system, in accordance with embodiments described herein;

FIG. 11 is a flow diagram showing an exemplary method for providing an availability management system, in accordance with embodiments described herein;

FIG. 12 is a block diagram of an exemplary computing environment suitable for use in implementing embodiments described herein; and

FIG. 13 is a block diagram of an exemplary distributed computing system environment suitable for use in implementing embodiments described herein.

### DETAILED DESCRIPTION

Distributed computing systems can support building, deploying and managing application and services. An increasing number of users and enterprises are moving away from traditional computing infrastructures to run their applications and services on distributed computing systems. As such, distributed computing system providers are faced with the challenge of supporting the increasing number of users and enterprises sharing the same distributed computing system resources. In particular, distributed computing system providers are designing infrastructures and systems to support maintaining high availability and disaster recovery for resources in their distributed computing systems. Conventional distributed computing systems struggle with supporting availability for large scale deployments of virtual machines. Distributed computing system providers can provide guarantees for availability but currently have limited configuration options to efficiently meet the guarantees to customer. Several different considerations have to be made, such as, how to place replica virtual machines to avoid data loss, how to guarantee a minimum number of active service virtual machines, understanding different types of failures and their impact on applications and services running on their distributed computing systems. As such, a comprehensive availability management system can be implemented to improve customer availability offerings and configurations for availability management in distributed computing systems.

Embodiments described herein are directed to methods, systems and computer storage media for availability management in distributed computing systems. An availability management system supports customizable, hierarchical and flexible availability configurations to maximize utilization of computing resources in a distributed computing system to meet availability guarantees for tenant infrastructure (e.g., customer virtual machine sets). An availability management system includes a plurality of availability zones within a region. An availability zone is a defined zone-tier isolated point of failure for a computing construct with a low-latency connection to other availability zones. The availability management system also includes a plurality of computing clusters defined within availability zones. The availability management system instantiates a plurality of cluster-tenants associated with the plurality of computing clusters, where a cluster-tenant is a defined instance of a portion of a computing cluster. As used herein, cluster-tenants are distinguished from tenants (i.e., customers) of a distributed computing system provider. The cluster-tenants are allocated to virtual machine sets for availability isolation tiers (e.g., a fault-tier or update-tier) that define isolated points of failures for computing constructs. Virtual machine sets having a plurality of virtual machines instances are allocated to cluster-tenants across availability zones or within a single availability zone based on tenant-defined availability parameters for availability.

In operation, an availability configuration interface of the availability management system supports receiving, from a tenant, availability parameters that are used to generate an availability profile. The availability profile comprises availability parameters (e.g., spanning or non-spanning multiple availability zones, rebalancing virtual machine instances between availability zones, number of fault domains, update domains, availability zones, etc.) associated with allocating, de-allocating and reallocating virtual machine instances of a virtual machine set to the plurality of availability zones.

The availability configuration interface also supports additional interface functionality. The availability configuration interface facilitates associating availability profile, generated based on the availability parameters, with a virtual machine set. The availability configuration interface may also be configured to specifically expose, via the availability configuration interface, logically-defined availability zones that map to physically-defined availability zones. For example, a single logically-defined availability zone may be mapped to multiple physically-defined availability zones or multiple logically-defined availability zones may be mapped to a single physically-defined availability zones. The logically-defined availability zones abstract the allocation of the virtual machine sets to the physically-defined availability zones.

The logically-defined availability zones allow for soft-allocations associated with sub-guarantees for allocating virtual machine sets. In this context, the logically-defined availability zones are unevenly-mapped to a fewer number of physically-defined availability zones. In particular, implementation templates or software logic associated with higher guarantees are utilized logically with a first set of logically-defined availability zones but physically implemented with a smaller second set of physically-defined availability zones. Nonetheless, the allocation of the virtual machine set meets the sub-guarantees agreed upon by the tenant based on an uneven-mapping of the logically-defined availability zones to the physically-defined availability zones. The availability configuration can also support querying and visually representing a tenant infrastructure based on the logically-defined availability zones that are mapped to the physically-defined availability zones.

The availability management system includes an availability manager. An availability manager is configured to: based on an availability profile, allocate the virtual machine sets across the plurality of availability zones using an allocation scheme. The allocation scheme may be a virtual machine set spanning availability zones allocation scheme for performing evaluations to determine an allocation configuration defined across at least two availability zones for allocating virtual machine sets. When the allocation configuration meets the availability parameters of the availability profile, the allocation scheme selects the allocation configuration for allocating the virtual machine set. The allocation scheme can alternatively be a virtual machine set non-spanning availability zones allocation scheme for performing evaluations for determining an allocation configuration defined for only a single availability zone and within a computing cluster for allocating virtual machine sets. When the allocation configuration meets the availability parameters of the availability profile, the allocation scheme selects the allocation configuration for allocating the virtual machine set. The allocation configurations in both cases can be defined based on sets of cluster-tenants of computing clusters.

As noted, it is contemplated that a virtual machine set may be allocated based on a virtual machine set non-spanning availability zones allocation scheme. As such, the virtual machine scale set is limited to a single availability zone. The virtual machine set can be either assigned to a plurality of cluster-tenants or a single cluster-tenant. The availability profile availability parameters can indicate whether the virtual machine set should be allocated to a plurality of cluster-tenants or a single cluster-tenant. Allocating a virtual machine set to a single cluster-tenant supports precise sub-zonal (e.g., fault-tier or update-tier) guarantees associated with fault domains and update domains. For example, with 5 fault domains, the customer can get strict guarantees that only virtual machine instances in one fault domain can go down at a time due to hardware failures. This results in 20% of virtual machine instances being down, but the customer knows exactly which 20% of the virtual machine instances are down. In contrast, allocating the virtual machine set to a plurality of cluster-tenants provides a less precise availability guarantee. For example, with fault domains per cluster-tenant, the customers can get an 80% availability guarantee, where 20% of the virtual machine instances go down due to hardware failure in a fault domain; however, the customer is unaware which specific virtual machine instances are down across the plurality of cluster-tenants.

In one embodiment, the allocation schemes can specifically determine an allocation configuration score for different allocation configurations for the virtual machine set in the at least two availability zones or within a single availability zone such that the allocation of the virtual machine set is based on the allocation configuration score. For example, allocation configuration scores for different allocation configurations can be compared with the allocation configuration associated with best allocation configuration score used as the allocation configuration for the virtual machine set. The allocation configuration score can be determined based on a current virtual machine instance count of a cluster-tenant, a remaining virtual machine instance to be allocated count and a maximum supported virtual machine count of the cluster-tenant. Other variations and combinations of evaluating allocation configurations scores for different allocation configurations and selecting an allocation configuration based on the allocation configuration score are contemplated with embodiments described herein.

The availability management system also supports scaling-out, scaling-in and rebalancing operations for allocating virtual machine sets to computing clusters. In operation, the availability manager specifically performs scaling-out, scaling-in and rebalancing operations for allocating and de-allocating the virtual machine sets. An allocation configuration that meets the availability parameters of the availability profile is determined; the allocation configuration is used for allocating the virtual machine set. The scaling-out, scaling-in and rebalancing operations can be performed using optimized schemes that maximize execution of the operations and the utilization of distributed system resources. The operations can also be implemented based on administrator-defined and/or tenant-defined configurations. In this regard, operations are performed based on the active availability configuration selections in the availability management system. As such, a comprehensive availability management system can be implemented to improve customer availability offerings and configurations for availability management in distributed computing systems.

Various terms are used throughout this description. Although more details regarding various terms are provided throughout this description, general definitions of some terms are included below to provider a clearer understanding of the ideas disclosed herein:

A region is a defined geographic location with a computing infrastructure for providing a distributed computing system. A distributed computing system provider can implement multiple interconnected (e.g., paired) or independent regions to provide computing infrastructure with high availability and redundancy and also close proximity to a customer using the computing infrastructure. Regions may typically not be associated with one another, but offered independently via a distributed computing system provider based on the geographic location of the physical resources used.

A region can include multiple availability zones, where an availability zone refers to an isolated point of failure (e.g., unplanned event or planned maintenance). Availability zones are isolated for failure based on separating several subsystems (e.g., network, power, cooling, etc.) that are used between availability zones. Availability zones are computing constructs that are proximate to each other to support low-latency connections. In particular, computing resources can communicate or be migrated between availability zones for performing operations in different scenarios.

An availability zone includes a computing cluster of connected computers (e.g., nodes) that are viewed as a single system. Computing clusters can be managed by a cluster manager, in that, the cluster manager provisions, de-provisions, monitors and executes operations for computing resources in the computing cluster. The computing cluster can support a virtual machine set (e.g., availability set or virtual machine scale set) that is a logical grouping of virtual machine instances. An availability set can specifically refer to a set of virtual machine instances that are assigned to a single cluster-tenant (e.g., 1:1 relationship) and a virtual machine scale set can refer to a set of virtual machine instances that are assigned to multiple cluster-tenants. In this context, an availability set can be a subset of a virtual machine scale set. The logical grouping can be protected against hardware failures and allow for updates based on fault domains and update domains. The fault domain is a logical group of underlying hardware that share common resources and the update domain is a logical group of underlying hardware that can undergo maintenance or be rebooted at the same time. The logical grouping of virtual machines instances are assigned to portions of a computing cluster based on instances of the computing cluster (i.e., cluster-tenants).

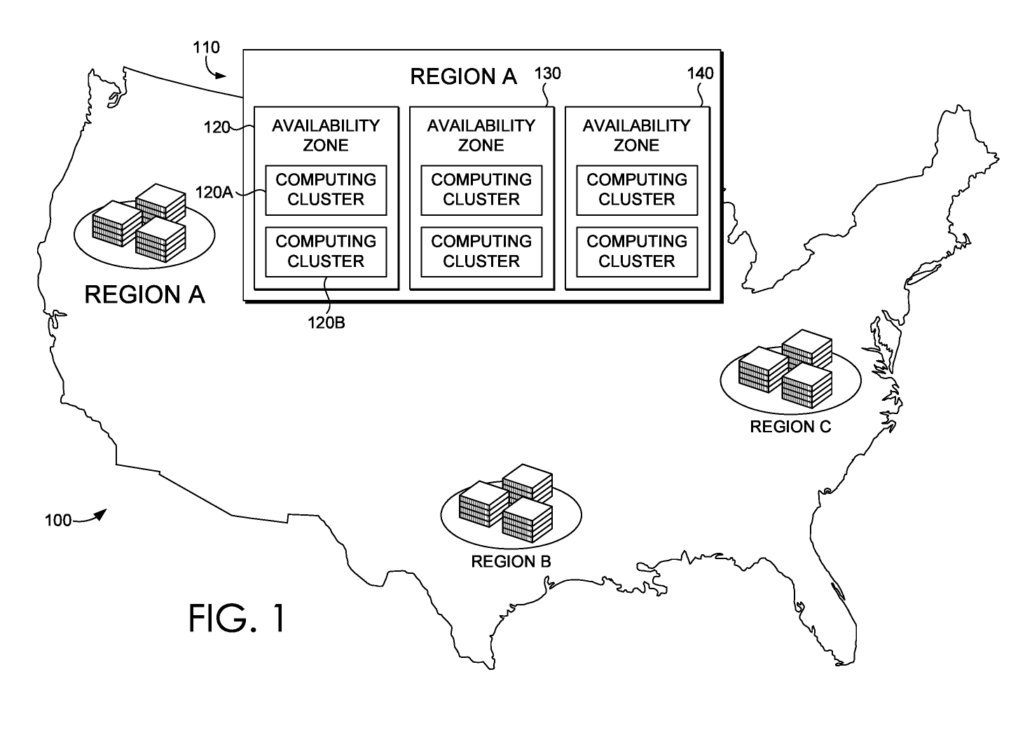

With reference to FIG. 1, embodiments of the present disclosure can be discussed with reference to an exemplary distributed computing system environment 100 that is an operating environment for implementing functionality described herein of an availability management system 110. The availability management system 110 includes region A associated with region B and region C. The availability management system 110 further includes availability zones (e.g., availability zone 120, availability zone 130 and availability zone 140). With reference to availability zone 120, an exemplary availability zone, availability zone 120 includes computing clusters (e.g., computing cluster 120A and computing cluster 120B). A computing cluster can operate based on a corresponding cluster manager (e.g., fabric controller) (not shown). The components of the availability management system 110 may communicate with each other via a network (not shown), which may include, without limitation, one or more local area networks (LANs) and/or wide area networks (WANs). Such networking environments are commonplace in offices, enterprise-wide computer networks, intranets, and the Internet.

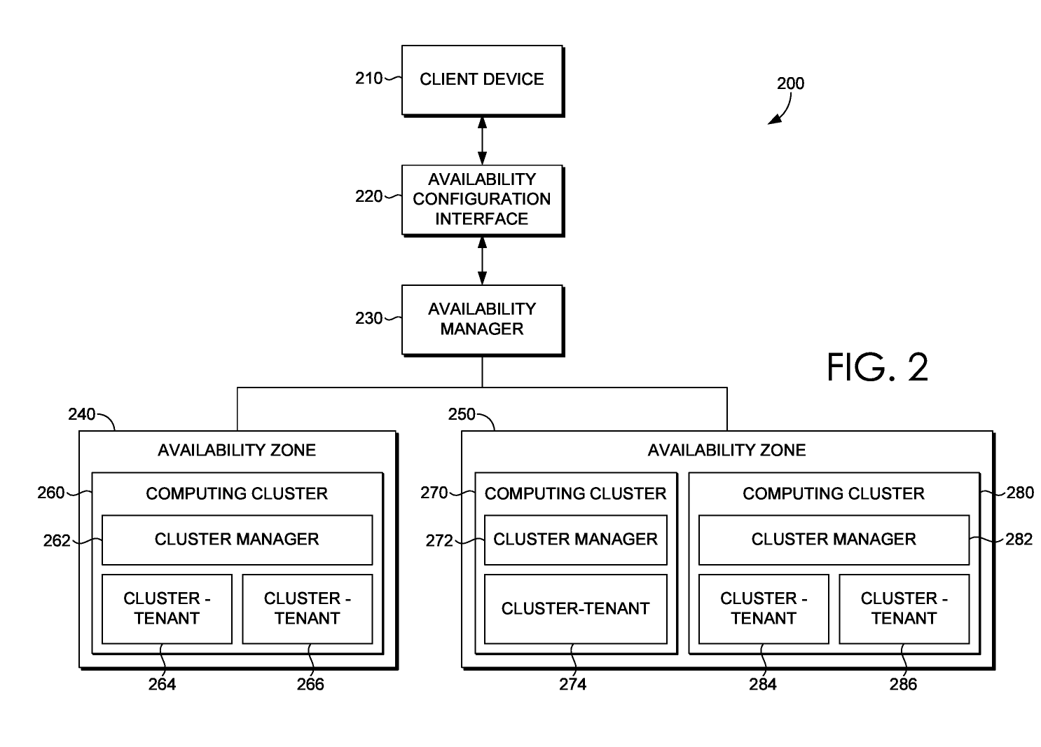

FIG. 2 illustrates a block diagram of an availability management system 200. FIG. 2 includes similar components shown and discussed in FIG. 1 with additional components supporting functionality of the availability management system 200. FIG. 2 includes client device 210, availability configuration interface 220, availability manager 230, availability zone 240 and availability zone 250. FIG. 2 further includes the availability zone 240 having a computing cluster 260 that includes cluster manager 262, cluster-tenant 264 and cluster tenant 266. The availability zone 250 has the computing cluster 270 and computing cluster 280 correspondingly having cluster manager 272, cluster-tenant 274 and cluster manager 282, cluster-tenant 284 and cluster-tenant 286, respectively. In combination, the components of the availability management system support functionality of the availability management system 200 as described herein in more detail.

A system, as used herein, refers to any device, process, or service or combination thereof. A system may be implemented using components as hardware, software, firmware, a special-purpose device, or any combination thereof. A system may be integrated into a single device or it may be distributed over multiple devices. The various components of a system may be co-located or distributed. The system may be formed from other systems and components thereof. It should be understood that this and other arrangements described herein are set forth only as examples.

Having identified various components of the distributed computing environment, it is noted that any number of components may be employed to achieve the desired functionality within the scope of the present disclosure. The various components of FIG. 1 and FIG. 2 are shown with lines for the sake of clarity. Further, although some components of FIG. 1 and FIG. 2 are depicted as single components, the depictions are exemplary in nature and in number and are not to be construed as limiting for all implementations of the present disclosure. The availability management system 200 functionality can be further described based on the functionality and features of the above-listed components.

Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

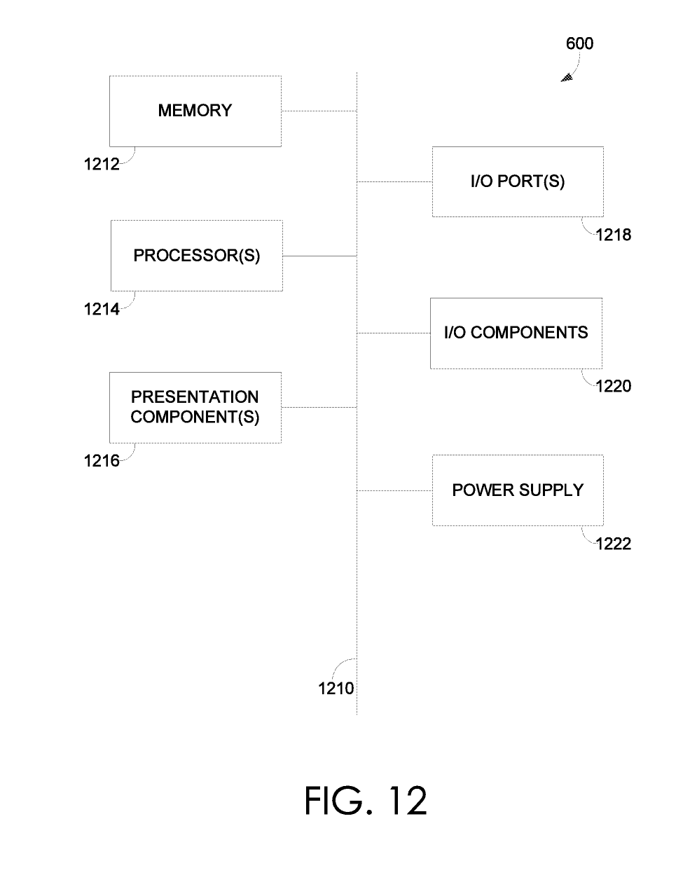

With continued reference to FIG. 2, the availability configuration interface 220 can generally refer to a point of interaction with the availability management system 200. The availability configuration interface 220 supports the exchange of information and configuration selections between software and hardware for the availability management system 200. In particular, the availability configuration interface 220 can support receiving, from a tenant of a distributed computing system, availability parameters used for generating an availability profile. The client device 210 can support accessing the availability configuration interface 220 for making selections for the availability parameters. The client device may be any type of computing device described with reference to FIG. 12. The availability parameters are settings in the availability management system 200 that are used to manage the tenant infrastructure (e.g., virtual machine sets). The availability parameters can be identified by an administrator of the availability management system 200 to provide the tenant with flexibility in configuring the availability of the tenant's infrastructure. Per the administrator's configuration, the availability parameters can be fixed or changeable and also the availability parameters can further include additional parameters specifically configured by the administrator but not selected by the tenant. The tenant is allowed to customize certain availability configurations.

The availability parameters that a tenant selects are used to generate an availability profile that can be associated with the virtual machine sets for allocating the virtual machine sets. As used herein, tenant (i.e., customer) of a distributed computing system provider is distinguished from a cluster-tenant (i.e. defined instance of a portion of a computing cluster for an underlying grouping of virtual machine instances). For example, a tenant creates virtual machine sets to be allocated in the distributed computing system and a cluster-tenant is associated with fault domains and update domains. The availability parameters can include selecting whether or not the virtual machine sets should be spanned or not spanned across availability zones. The tenant can also select whether a virtual machine set should be rebalanced or not rebalanced automatically or through manual intervention across the availability zones based on defined triggers. The availability parameters can also include selecting availability isolation tiers (i.e., region-tier, zone-tier, fault-tier and update-tier) for allocating the virtual machine sets. The availability isolation tiers can be tiers that define failure isolation or operational isolation, such that, a virtual machine set remains highly available and redundant.

In this context, the tenant has a customizable, hierarchical, flexible and granular implementation of availability for their different virtual machine sets. For example, the availability parameters can support the tenant selecting a number of fault domains only or fault domain and update domains, one availability zone or multiple availability zones. Different availability parameters (i.e., an allocation scheme and one or more availability isolation tiers) can be assigned to different types of virtual machine sets to achieve certain availability goals. The different types of virtual machine sets can be correspondingly assigned to computing clusters based on determining allocation configurations in the availability zones that meet the availability parameters, where an allocation configuration indicates an arrangement of virtual machine instances within a distributed computing system (i.e., cluster-tenant, computing cluster, and availability zones). Other variations and combinations of availability parameters are contemplated with embodiments described herein.

The availability configuration interface 220 can support causing the generation of an availability profile. The availability parameters are used to generate an availability profile which can be associated with a virtual machine set. Defining the virtual machine set and associating the virtual machine set with an availability profile can also be performed using the availability configuration interface.

The availability configuration interface 220 may expose to the tenant (e.g., via client device 210) logically-defined availability zones that map to physically-defined availability zones. The logically-defined availability zones abstract the allocation of the virtual machine sets to the physically-defined availability zones. The logical to physical mapping allows flexibility in allocating virtual machine sets to availability zones. For example, a single datacenter may be associated with multiple availability zones or multiple datacenters can define one availability zone. The physical computing constructs that define availability zones can be abstracted from the tenant such that the tenant views their infrastructure based on logically-defined availability zones.

The logically-defined availability zones further allow the availability configuration interface 220 to provide an availability parameter for soft-allocations associated with sub-guarantees for allocating virtual machine sets. In this context, the logically-defined availability zones are unevenly-mapped to a fewer number of physically-defined availability zones. In particular, the underlying mechanism for implementing the availability management system (e.g., software logic and templates) can be associated with a first set of availability guarantees for a first physical number of availability zones. However, when there exist locations without enough physical availability zones, the first set of availability guarantees cannot be met. In order to utilize the same software logic and templates, soft-allocations with sub-guarantees can be provided as an alternative availability configuration for tenant. In operation, the logical availability zones are implemented with a smaller set of physical availability zones. Nonetheless, the allocation of the virtual machine set meets the sub-guarantees agreed upon by the tenant based on an uneven-mapping of the logically-defined availability zones to the physically-defined availability zones. It is contemplated that other variations and combinations of mappings between logically-defined availability zones and physically-defined availability zones are contemplated with embodiments described herein. For example, a single logically-defined availability zone may be mapped to multiple physically-defined availability zones or multiple logically-defined availability zones may be mapped to a single physically-defined availability zones.

The availability configuration interface 220 can also support providing information about a tenant's infrastructure (e.g., virtual machine sets) to the tenant. The availability configuration interface 220 may support querying and providing a visual representation of the virtual machine sets and their corresponding availability settings (e.g., fault domains, update domains, computing clusters, availability zones, etc.) in the distributed computing system. For example, the tenant may query via the availability configuration interface 220 locations of a particular virtual machine sets and the availability set domains and availability zone within which the virtual machines of the virtual machine sets can be provided. The virtual machine sets can be visually represented based on logically-defined availability zones that are mapped to the physically-defined availability zones. A visual representation can include a graphical representation or a text-based representation based on identifiers associated with the computing clusters, availability zones and the virtual machine sets.

Turning to availability manager 230 of the availability management system 200, the availability manager 230 operates to allocate virtual machine sets to computing clusters (e.g., computing cluster 260, computing cluster 270 and computing cluster 280). As used herein, allocation may also further mean to de-allocate unless otherwise stated. The availability manager 230 can be implemented in a distributed manner and operate with cluster managers (e.g., an availability manager service or client—not shown) to allocate virtual machine sets to the computing clusters. As discussed herein, operations performed at the cluster manager can be initiated via the availability manager or at the cluster manager operating based on the availability manager services or clients. The availability manager 230 also supports scaling-out, scaling-in and rebalancing operations for allocating virtual machine sets to computing clusters across availability zones.

Availability configurations may be based on strict physical fault domain and update domain semantics. For example, allocating virtual machine sets into computing clusters of a distributed computing system can come with guarantees to spread the virtual machine set into different fault domains and update domains associated with the computing cluster. A fault domain (FD) can essentially be a rack of servers using the same subsystems like network, power, cooling etc. So, for example, with 2 virtual machine instances in the same virtual machine set means the availability manager 230 will provision them into 2 different racks such that if, for example, the network or the power failed, only one of the virtual machine instances would be affected. For some categories of network or power failure, only one of the virtual machine instances would be affected. However, the availability guarantees of a fault domain are weaker than the ones of availability zones when it comes to how much an availability zone is resilient to network or power failure as compared to another availability zone.

With reference to update domains, applications may need to be updated or a host running a VM may need an update. The availability manager 230 supports performing updates without taking a service supported by the virtual machine instances offline. Update domains can include purposeful moves to take down virtual machine instances such that the service does not go offline because of an update. Nonetheless, allocation of virtual machine done strictly based on individual computing clusters and their corresponding fault domains and update domains may not fully utilize resource capacity of a distributed computing system where there exists more resource capacity in other computing clusters of a region.

With embodiments described herein, the availability manager 230 can support percentage availability by distributing virtual machine sets across different availability isolation tiers of computing constructs (e.g., fault domains, update domains, and availability zones). At a high level, virtual machine sets for a tenant can be allocated to a distributed computing system based on tenant-defined availability parameters that allow for virtual machine set spanning or virtual machine set non-spanning at zone-tier, fault-tier and update-tier isolation tiers to meet tenant availability goals. Allocating virtual machines instances can specifically be based on instantiating cluster-tenants, for the virtual machine instances, across several computing clusters in different availability zones. For example, the availability management system 200 can be configured to allow one or more cluster-tenants per computing cluster for a virtual machine set. The availability manager 230 also allocates virtual machine sets to computing clusters and availability zones when scaling-out and scaling-in. Advantageously, the availability management system 200 supports meeting availability isolation tier parameters based on spanning virtual machine instances in a virtual machine set across computing clusters and availability zones for better utilization of distributed computing system resource capacity. In particular, virtual machine sets that span multiple cluster-tenants and computing clusters build on the availability guarantees provided at the fault-tier and upgrade-tier of every cluster-tenant to offer overall percentage-based guarantees. This further supports large scale deployments of virtual machines for tenants with flexible high availability and disaster recovery guarantees.

As discussed, the availability management system 200 can support an availability configuration interface 220 that allows the selection of availability parameters including a number of fault domains and update domains. Nonetheless, in one embodiment, the Update Domain (UD)/Fault Domain (FD) (“UD/FD”) count is fixed (5UDs/3FDs). In particular, the fixed UD/FD configuration can be for virtual machine sets (e.g., availability sets) and specifically for cluster-tenants associated with virtual machine sets. The availability manager 230 can operate to instantiate cluster-tenants, with the fixed UD/FD, across computing clusters and availability zones. The availability isolation tiers can also be logical-defined based on underlying physical hardware. In this context, availability parameters for availability isolation tier can be met based on underlying physical hardware across two or more availability zones. By way of example, a virtual machine set may be supported using 3 logical FDs and 5 logical UDs in every availability zone and a plurality of more FDs and UDs across availability zones based on underlying physical hardware. Advantageously, a virtual machine set can be distributed evenly across availability zones to meet availability parameters based on logically or physically defined isolation computing constructs, as discussed herein with reference exemplary algorithms.

By way of example, within an availability zone, virtual machine instances of a virtual machine set are allocated to computing clusters. In an availability zone, virtual machine instances are allocated to multiple cluster-tenants within the same computing cluster or different computing clusters. Each cluster-tenant may be configured to host a predefined maximum number (e.g., 100) of virtual machine instances to support capacity limitations of the computing clusters. It is contemplated that when performing scaling-out operations, existing cluster-tenants may not be allocated virtual machine instances due to computing cluster capacity. New cluster-tenants can be instantiated to allocate virtual machine instances on different computing clusters with capacity. Within each cluster-tenant, virtual machine instances may further be distributed evenly across failure isolation constructs (e.g., “fault domain” (FD) or “fault domain:update domain” FD:UD). The availability manager 230 can also support availability management during allocation and de-allocation of virtual machine sets based on scaling-out and scaling-in operations.

With reference to scaling-out operations, an exemplary algorithm can include the availability manager 230 distributing the virtual machine instances equally (or substantially equally) across availability zones provided by the tenant. Substantially equally can refer to a situation with an odd number of virtual machine instances, as such, the virtual machine instance are distributed as evenly as possible. The availability management system 200 can also be configured to initially add the virtual machine instances to availability zones which have the least number of virtual machine instances. In situations where virtual machine instance count in the availability zones are the same (i.e., a tie), then an availability zone can be picked by any other predefined method, including a random selection. For simplicity in this detailed discussion, a random selection of method is used in tie-breaker situations; however other predefined methods for making selections in tie-breaker situations are contemplated with embodiments described herein.

Within an availability zone, the availability manager 230 is configured to fill up virtual machine instances to existing cluster-tenants associated with the virtual machine set. For example, a cluster-tenant can be configured to have a maximum of 100 virtual machine instances (MaxVMsPerCT). If the scaling-out an existing cluster-tenant is not possible because the corresponding computing cluster is at capacity for the computing cluster, the availability manager can allocate the virtual machine instances to a cluster-tenant of the availability set on a different computing cluster. The availability manager 230 is also responsible for limiting the impact of fragmentation of virtual machine instances in cluster-tenants when the virtual machine instances become unevenly distributed as discussed above. The availability manager 230 can stop instantiating cluster-tenants based on a threshold number of virtual machine instances. This would obviate some unexpected allocation configurations of virtual machines instances.

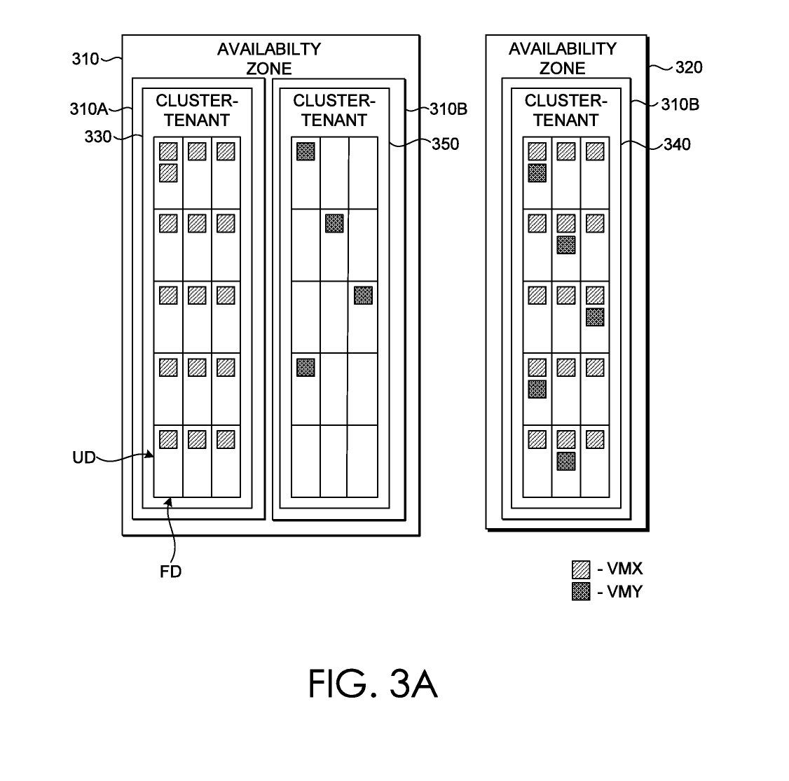

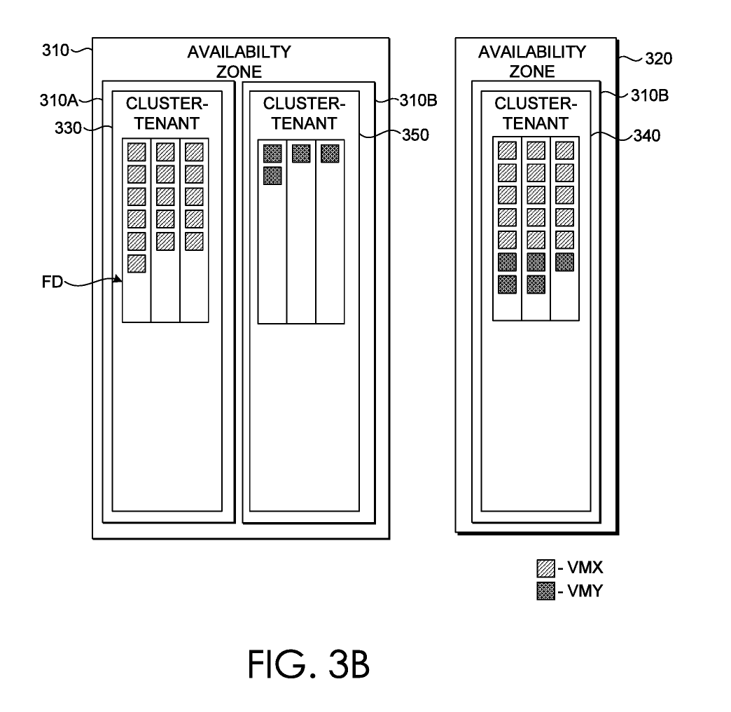

As depicted in FIG. 3A, FIG. 3A illustrates an outcome of scaling-out operations with fault domains and update domains. FIG. 3A includes availability zone 310 and availability zone 320. Availability zone 310 includes computing cluster 310A and computing cluster 310B. As shown, availability zones include horizontally constructed UDs and vertically constructed FDs within cluster-tenants in computing clusters. Accordingly, availability zone 310 further includes cluster-tenant 330 having 5UDs and 3FDs and cluster-tenant 350 having 5UDs and 3FDs. Availability zone 320 includes computing cluster 320A with cluster-tenant 340 having 5UDs and 3FDs. The tenant virtual machine set has 31 virtual machine instances that have to be scaled-out to 40 virtual machine instances. VMX denotes virtual machine instances that existed before performing scaling-out operations and VMY are virtual machine instances allocated to computing clusters after performing scaling-out operations.

Prior to performing scaling-out operations, the virtual machine set, of 31 virtual machine instances, was distributed over the 2 availability zones—availability zone 310 and availability zone 320. 16 virtual machine instances were in availability zone 310 and 15 virtual machines were in availability zone 320. After performing scaling-out operations, 4 virtual machine instances have been allocated to availability zone 310 and 5 virtual machines have been allocated to availability zone 320. Each availability zone has 20 virtual machines after scaling-out.

During scaling-out operations, a determination was made that the computing cluster 310A was at capacity, as such, a new computing cluster 310B was then created in availability zone 310 and then an action was taken to allocate 4 virtual machine instances to cluster-tenant 350 in computing cluster 310B and distributed across the fault domains and update domains. In availability zone 320, the computing cluster 320A still had capacity for cluster-tenant 340, so an action was taken to allocate 5 virtual machine instances to cluster-tenant 340 and distributed evenly across fault domains and update domains.

With reference to FIG. 3B, FIG. 3B illustrates a scaled-out virtual machine set in accordance with embodiments described herein. In particular, the scaled-out operations have been performed for a merged update domain and fault domain configuration. Availability zones include only vertically constructed FDs within cluster-tenants in computing clusters. As shown, the virtual machine set has been scaled-out from 31 virtual machine instances to 40 virtual machine instances. VMX denotes virtual machine instances allocated before scaling-out and VMY denotes virtual machine instances that have since been allocated to scale-out the virtual machine set.

Prior to scaling-out the virtual machine set, the virtual machine set was allocated to 2 availability zones—availability zone 310 and availability zone 320. 16 virtual machines were allocated to availability zone 310 and 15 virtual machine instances were allocated to availability zone 320. After scaling-out the virtual machine set, 4 virtual machine instances were allocated to availability zone 310 and 5 virtual machine instances were allocated to availability zone 320. Each availability zone now has 20 virtual machines after performing scaling-out operations.

During scaling-out operations, a determination was made that the computing cluster 310A was at a capacity and a new computing cluster 310B with cluster-tenant 350 was created. An action was taken to allocate 4 virtual machines to cluster-tenant 350 in computing cluster 310B and distributed across the fault domains. In availability zone 320, the computing cluster 320A still had capacity, as such, an action was taken to allocate 5 more virtual machine instances to the cluster-tenant 340 of the computing cluster 320A and distributed across the fault domains.

With reference to scaling-in operations, an exemplary algorithm can include the availability manager 230 supporting performing scaling-in operations to delete virtual machine instances distributed across availability zones and cluster-tenants (CT) of computing clusters. The availability manager 230 can first determine a virtual machine instance count to be deleted from each availability zone. The availability manager 230 will delete virtual machine instance from the corresponding availability zone which contains the most virtual machine instances. If the virtual machine instance count is the same in all availability zones, then a predefined method, including a random selection can be used to select an availability zone, until the virtual machine count equals the virtual machine instance count indicated by the tenant. For simplicity in this detailed discussion, a random selection of method is used in tie-breaker situations; however other predefined methods for making selections in tie-breaker situations are contemplated with embodiments described herein.

In operation, for each availability zone, a virtual machine instance count is determined for each CT:FD:UD pair. A virtual machine instance is removed from the CT:FD:UD pair which has the maximum virtual machine instance count. Inside the CT:FD:UD pair, the virtual machine instance with the max instance ID will be removed. If there exist CT:FD:UD pairs which contain the same maximum virtual machine instance count and the virtual machine instances to be deleted count is less than the pair count, the following actions are taken:

Select a cluster-tenant with a max cluster-tenant ID. If the CT:FD:UD pair count in the cluster-tenant is less than or equal to virtual machine instances to be deleted count, then an action is taken to delete the virtual machine instance with max instance ID in the pairs in the cluster-tenant and move to next cluster-tenant. If the CT:FD:UD pair count in the cluster-tenant is greater than virtual machine instances to be deleted count, the following action are taken:

Select the FD in the cluster-tenant which has the max virtual machine instance count. If there exists more than one FD that has the same max virtual machine instance count, randomly select an FD. In the FD, select one virtual machine instance from a UD which contains the max virtual machine count. If there exists more than one UD that has the same max virtual machine instance count, randomly select a UD. Delete the selected virtual machine instance and continue to select the next virtual machine instance to delete by the same logic.

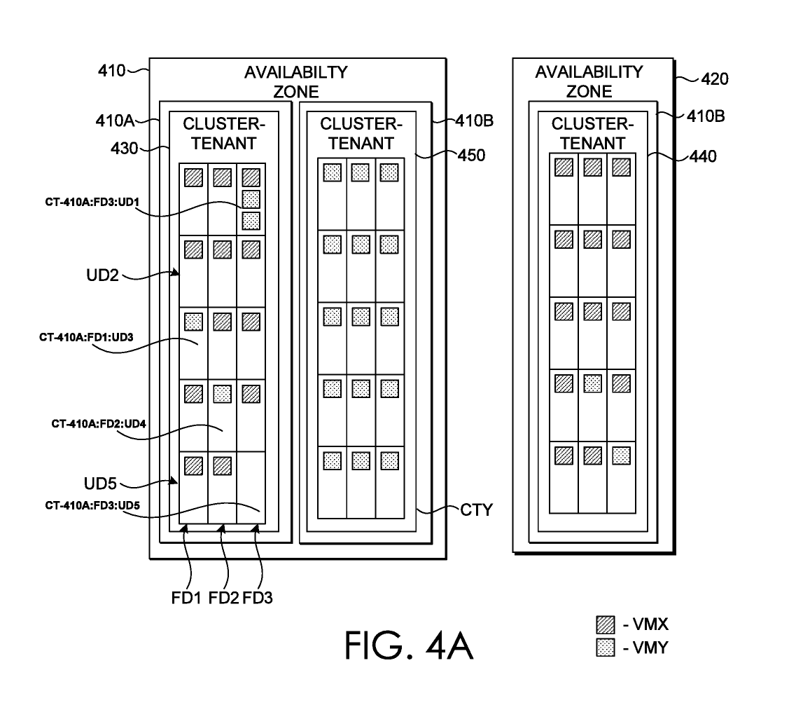

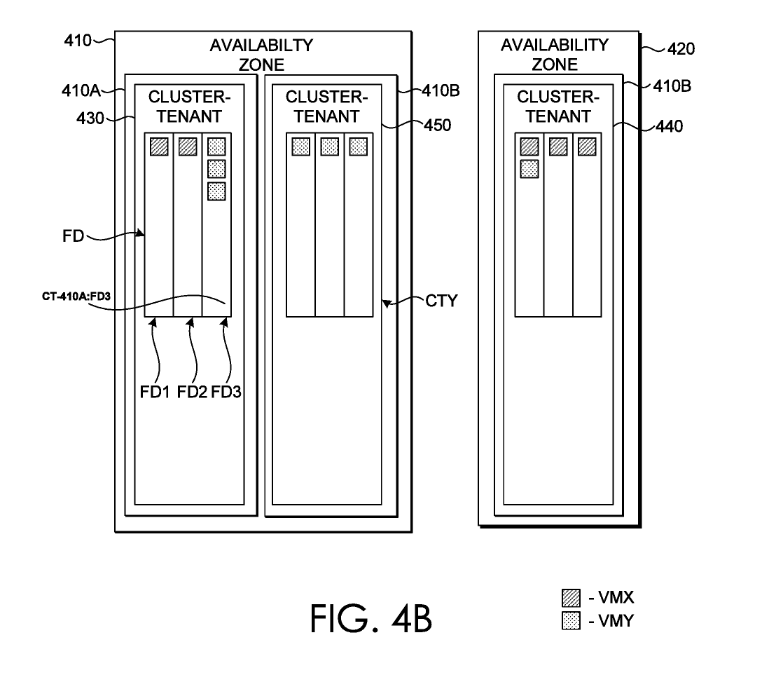

As depicted in FIG. 4A, FIG. 4A illustrates an exemplary outcome of scaling-in operations with fault domains and update domain. FIG. 4A includes availability zone 410 and availability zone 420. Availability zone 410 includes computing cluster 410A and computing cluster 410B. As shown, availability zones include horizontally constructed UDs and vertically constructed FDs within cluster-tenants in computing clusters. Accordingly, availability zone 410 further includes cluster-tenant 430 having 5UDs and 3FDs and cluster-tenant 450 having 5UDs and 3FDs. Availability zone 420 includes computing cluster 420A with cluster-tenant 440 having 5UDs and 3FDs. The tenant virtual machine set has 46 virtual machine instances that have to be scaled-in to 25 virtual machine instances. VMX denotes virtual machine instances that remain after the scaling-in operations have been performed. VMY denotes virtual machine instances that were deleted after performing the scaling-in operations. CTY denotes a cluster-tenant that has been removed after scaling-in operations.

Prior to performing scaling-in operations the virtual machine set was distributed across 2 availability zones—availability zone 410 and availability zone 420. Availability zone 410 had 31 virtual machines and availability zone 420 had 15 virtual machine instances. Availability zone 410 had 16 virtual machine instances in cluster-tenant 330 and 15 virtual machine instances in cluster-tenant 350. Scaling-in operations were performed to delete 21 virtual machine instances. 19 virtual machine instances were deleted from availability zone 410, 2 virtual machine instances were deleted from availability zone 420.

After performing scaling-in operations, availability zone 410 has 12 virtual machines and availability zone 420 has 13 virtual machines instances. With specific reference to availability zone 410, from which 19 virtual machine instances were deleted, a determination was made that CT-410A: FD3: UD1 had the maximum virtual machine instance count of 3. As such, an action was taken to delete 2 virtual machine instances from CT-410A: FD3: UD1. 17 virtual machines were remaining to be in availability zone 410.

Further in availability zone 410, a determination was made that all computing CT:FD:UD pairs had 1 virtual machine instance except for cluster instance CT-410A:FD3:UD5 which did not have any virtual machine instances. As such, for availability zone 410, there existed 29 candidate pairs, the virtual machine count which is greater than the virtual machines to be deleted in the availability zone 410.

In availability zone 410, cluster-tenant 410B was selected as the cluster-tenant with the max ID. There existed 15 pairs, which was less than 17 virtual machine instances remaining to be deleted. An action was taken to delete 1 virtual machine instance in each pair in cluster-tenant 410B. Cluster-tenant 410B was now an empty cluster-tenant. An action was also taken to delete cluster-tenant 410B denoted as CTY. There are 17−15=2 virtual machines instance left to be deleted.

The evaluation continued to back to cluster-tenant 410A. A determination was made that FD1 and FD2 both have the max virtual machine instance count—5. FD2 was randomly selected. In FD 2, a determination was made that UD1, UD2, UD3 and UD4 have the same max virtual machine instance count. UD4 was randomly selected. An action was taken to delete 1 virtual machine instance from UD4. There existed 1 virtual machine instance remaining to be deleted. In FD1, a determination was made that FD1 has the max virtual machine instance count of 5. In FD1, UD1, UD2 and UD3 have the same max virtual machine count. So UD3 was randomly selected. An action was taken to delete 1 virtual machine instance from CT-410A:FD1:UD3.

With reference to FIG. 4B, FIG. 4B illustrates a scaled-in virtual machine set in accordance with embodiments described herein. In particular, the scaled-in operations have been performed for a merged update domain and fault domain configuration. As shown, availability zones include only vertically constructed FDs within cluster-tenants in computing clusters. As shown, the virtual machine set has been scaled-in from 12 virtual machine instances to 5 virtual machine instances. VMX denotes virtual machines remaining after the scaling-in, VMY denotes virtual machine instances that have been removed after scaling-in, CTY denotes a cluster-tenant that has been removed after scaling-in operations.

Prior to performing scaling-in operations, the virtual machine set was distributed across 2 availability zones—availability zone 410 and availability zone 420. Availability zone 410 had 8 virtual machines and availability zone 420 had 4 virtual machines. In availability zone 410, 5 virtual machines were in cluster-instance 410A and 3 virtual machines were in cluster-instance 410B.

During scaling-in operations, actions were taken to delete 7 virtual machine instances, in particular, 6 virtual machines were deleted from availability zone 410 and 1 virtual machine was deleted from availability zone 420. With reference to availability zone 410, while performing the scaling-in operations, a determination was made that CT-410A:FD3 pair had the maximum virtual machine count of 3. An action was taken to delete 2 virtual machine instances from the CT-410A:FD3 pair. This left 4 virtual machine instances to be deleted in availability zone 410. A determination was made for availability zone 410 that all remaining CT-410A:FD pairs have 1 virtual machine. As such, for availability zone 410, 6 candidate pairs was the virtual machine instance count of which was greater than virtual machines to be deleted in availability zone 410.

In availability zone 410, cluster-tenant 410B was selected as the cluster-tenant with the max ID. There existed 3 pairs, which was less than 4 VMs remaining to be deleted. An action was taken to delete 1 virtual machine in each pair. Cluster-tenant 410B was now empty. An action was taken to delete cluster-tenant 410B. There were 4−3=1 virtual machine instance left to be deleted. The scaling-in operation continued to cluster-tenant 410A. A determination was made that FD1, FD2 and FD3 had the max virtual machine instance count of 1. FD3 was randomly selected. An action was taken to delete 1 virtual machine instance from CT-410A:FD3.

As discussed, the availability manager 230 supports scaling-out and scaling-in operations. The availability manager 230 may implement different types of optimized algorithms for allocating and de-allocating virtual machine instances. Several optimized algorithms can support efficient allocation, de-allocation and rebalancing of virtual machine instances. An allocation-configuration-score-based scheme can be implemented for allocating virtual machine instances. In operation, a tenant may create a virtual machine set having virtual machine instances. Initially, the virtual machine sets are not assigned a cluster-tenant. The virtual machine instances can be processed and assigned to availability zones having the lowest virtual machine counts. It is contemplated that as new virtual machine instances are created, they are also processed and assigned to availability zones with the lowest virtual machine counts.

For a selected existing cluster-tenant representing, associated with availability zone, a determination is made whether a virtual machine instance is not assigned to a cluster-tenant. When it is determined that a virtual machine instance has not yet been assigned to a cluster-tenant, a determination is made whether the virtual machine instance count of the cluster-tenant is less than the max virtual machine count per cluster-tenant (MaxVMsPerCT). When the virtual machine instance count of the cluster-tenant is not less than the MaxVMsPerCT, a new cluster-tenant is selected for performing the evaluation. When the virtual machine instance count of the availability is less than the MaxVMsPerCT, an allocation configuration score determination is made.

The allocation configuration score determination is made for the existing cluster-tenant. The allocation configuration score for a cluster-tenant can be an indication of available allocation capacity for virtual machine instances based on both the cluster-tenant and the computing cluster where the cluster-tenant is located. For example, the cluster-tenant may have allocation capacity but the computing cluster where the cluster tenant is located may further limit the allocation capacity (i.e., the allocation configuration score). The allocation configuration score request can be for the cluster-tenant and computing cluster or for the cluster tenant only. The allocation configuration score request is made only for the virtual machine instance count such that the total virtual machine count in a cluster tenant is less than MaxVMsPerCT. As such, a determination whether a current virtual machine count for a cluster-tenant plus a remaining virtual machine instance count to be allocated is less than the MaxVMsPerCT. The allocation configuration score determination can be represented as: Min (current VM count+remaining VM instance count, MaxVMsPerCT).

For example, a MaxVMsPerCT can be 100 VMs and a current virtual machine count can be 90 and a remaining virtual machine instance count can be 20. In this case, the allocation configuration score yields 100 for the MaxVMsPerCT which is less than 110 and the determination answer is no and another cluster-tenant is selected. In another example, the MaxVMsPerCT is also 100 and a current virtual machine count is 90 and a remaining virtual machine count is 3. In the second case, the allocation configuration score yields 93 for the current virtual machine count plus the remaining virtual machine count and the determination answer is yes. An allocation of virtual machine instances is performed as a function of the remaining virtual machine instance count (i.e., 3), the MaxVMsPerCT (i.e., 100) and the current virtual machine count (i.e., 90) The allocation can be performed based on Min (remaining virtual machine instance count (3), MaxVMsPerCT (100)—current virtual machine count (95)) which yields 3. As such 3 virtual machine instances as assigned to the cluster-tenant. In this context, an allocation configuration score can indicate an amount of virtual machine instances that can be assigned to a cluster-instance. When existing cluster-tenants are at capacity, the algorithm includes creating a new cluster-tenant and allocating virtual machine instances to the new cluster-tenant. For each new cluster-tenant, an allocation configuration score can be determined after assigning an initial number of virtual machine instances and assigned as property of the cluster-tenant for the cluster manager. It is contemplated that assigning virtual machine instances to existing cluster-tenants or new cluster-tenants can be based initially reserving an allocation capacity on the existing cluster-tenant or the new cluster-tenant prior to actually allocating the virtual machine instances to the existing cluster-tenants and the new cluster-tenant. As discussed in more detail below, during scaling-out operations for an existing cluster-tenant, an additional consideration or factor is the available capacity in the computing cluster where the cluster-tenant is located. Initiating a reservation operation for an existing cluster-tenant determine whether there exists capacity in the computing cluster. Further, if a reservation operation is initiated and no availability capacity exists, a GetAllocationScore operation executed for other available computing clusters provides an indication of which computing clusters have the most available capacity to satisfy the scale-out request.

Allocation requests for allocation virtual machine set can include two-pass sort-and-filter and bucketing scheme for identifying and reserving computing clusters. For example, an allocation request is received. The allocation request is received for a virtual machine set of a tenant. The allocation request is received at the availability manager 230 that supports allocation the virtual machine set. The availability manager 230 can identify computing clusters (e.g., fabric stamps) for a particular region having a plurality of availability zones. The availability manager 230 may sort and filter the computing clusters to identify a subset of ideal computing clusters. The availability manager 230 may initially filter the computing clusters based on a plurality of constraints. For example, the availability manager 230 can filter the computing clusters based on network capacity and virtual machine instance size capacity, amongst other dynamic constraints. The availability manager 230 may also filter the computing clusters by generating list (e.g., clusterToExclude list) which may be used to prioritize selection of computing clusters. The availability manager may filter the computing cluster based on hard utilization limits, sort reservations, health score, amongst other administrator-defined filtering parameters. Upon sorting and filtering, the availability manager 230 can generate a queue of computing clusters (e.g., ComputingClusterCandidateQueue).

The availability manager 230 can operate to access the queue for allocation the virtual machine set. Initially, the availability manager 230 can dequeue a predefined number (e.g., N) computing clusters to build a bucket of computing clusters. For example, when N=5 the availability manager dequeues 5 computing clusters from the queue to generate a computing cluster bucket. If the availability manager is unable to dequeue any computing clusters, then there are no computing clusters available to be reserved. If the availability manager 230 is able to dequeue computing clusters then a series of operations can be performed.

In particular, for computing clusters in the computing cluster bucket, a second sort and filter operation can be performed. The second sort and filter operation includes first, getting cluster-tenant allocation configuration scores and then filtering the computing clusters based on a hard utilization limit and sorting by one or more of the following: soft reservation, health score and allocation configuration score to help identify which computing clusters have the most available capacity. For each computing cluster, virtual machine instances may be allocated to the computing cluster based on the sorted and filtered list.

Allocation requests for allocation of virtual machines can include cluster-tenant reservation scheme for identifying and reserving computing clusters. A determination is made whether any virtual machine instances in a virtual machine set are available to be allocated. The availability manager dequeues a predefined number (e.g., N) unallocated virtual machine instance. For example, N can be equal to 200. The availability manager can create a cluster-tenant definition that will initialize N virtual machine instances. The virtual machine instances can be distributed evenly across failure isolation computing constructs (e.g., fault domain and/or update domains). It is contemplated that for a last batch of virtual machine instances, the virtual machine instances may be distributed unevenly.

Further, a list of cluster-tenants to be excluded may be determined. Cluster-tenants to be excluded can be selected based on a maximum number of tenants per cluster (e.g., MaxNumClusterTenantsPerCluster) and from existing cluster-tenant placement (e.g., ExsistingClusterTenantPlacement). The availability manager can submit a cluster-tenant reservation request with the list of cluster-tenants to exclude. A determination is made whether or not cluster-tenants can be reserved for allocating virtual machine instances.

An allocation optimization for scaling-out virtual machines can further include identifying balanced and unbalanced cluster-tenants for making allocation decisions. A determination is made, for cluster-tenants, whether the number of virtual machine instances in the cluster-tenant (i.e., ClusterTenantSize) is less than the maximum number of virtual machine instance for the cluster-tenant (i.e., MaxNumVMIntancesPerCT). The cluster-tenants can be grouped into an unbalanced cluster tenant list (e.g., unbalancedClusterTenants) and a balanced cluster-tenant list (e.g., BalancedClusterTenantList). For unbalanced cluster-tenants and the balanced cluster-tenants, the list is sorted based on the remaining capacity, and put into a sorted list queue. Virtual machine instances can be allocated to the unbalanced and balanced cluster-tenants. It is possible that the availability manager, based on the capacity of the cluster-tenants, can run a new tenant allocation algorithm to create new tenants.

A scale-in optimization can include determining a rebalancing cost for a cluster-tenant. A scale-in request for M virtual machine instances may be received. A determination is made whether there are cluster-tenants whose virtual machine instances are not evenly distributed across isolated domains (e.g., fault domains and/or update domains). When it is determined that the virtual machine instances are not evenly distributed, for each unbalanced cluster-tenant a rebalancing cost can be determined (e.g., a function—FindRebalancePlanWithLeastCost). For example, the number of virtual machine instances needed to be deleted to balance the cluster-tenant. The higher the number of virtual machine instance count the higher the rebalancing cost. The list of cluster-tenants can be sorted by least rebalancing cost in ascending order. The cluster-tenants are scaled-in using a rebalancing plan with least cost (i.e., shortest path to balance). When it is determined that the virtual machine instances are evenly balanced, the cluster-tenants are sorted in ascending order. An action is taken to perform aggressive scaling for each of the cluster-tenants starting with the smaller ones.

With reference to rebalancing operations, the availability manager can support performing rebalancing operations. Several different factors may trigger a rebalancing operation. A rebalancing operation may refer to one or more steps taken to move virtual machine instances between availability zones. Factors that initiate rebalancing can include failure-based factors (e.g., an availability zone is down or unhealthy such that virtual machine instances at the availability zone are not accessible) or change-based factors (e.g., a tenant deleting specific virtual machine instances and a tenant changing availability parameters (e.g., an availability zone) for a virtual machine set). Other factors can also include scaling out, or increasing a number virtual machine instances, or failure of an availability zone, such that new virtual machine instances have to be assigned to other availability zones.

Embodiments of the present invention can be further described based on exemplary implementations of rebalancing. By way of example, four different rebalancing triggers can be defined within the availability management system. First, an availability zone is down or unhealthy such that virtual machine instances at the availability zone are not accessible. Second, an availability zone that was previously unhealthy is now healthy virtual machine instances can be allocated to the availability zone. Third, an availability zone having additional capacity (e.g., based on a threshold capacity) such that additional virtual machine instances can be allocated to the availability zone. And fourth, tenant action that requires virtual machine instances to be re-allocated.

The availability manager may receive an indication that a rebalancing triggering event has occurred, such that, rebalancing operations are initiated for one or more virtual machine sets. The rebalancing operations can be based on the particular type of trigger. For example, if an availability zone is down, the availability manager may tag the virtual machine instances in the corresponding availability zone as deleted and create new virtual machine instances in healthy availability zones. For all other scenarios, rebalancing operations can include creating new virtual machines instances in availability zones that have recovered from an unhealthy state or determined to have additional capacity. Rebalancing operations are in particular performed based on an availability profile of the virtual machine set.

Rebalancing operations can be optimized based on a two-part allocation and rebalance algorithm described below. In operation, the availability manager via the cluster manager can logically delete virtual machines instances from unhealthy availability zones. New virtual machine instances can be created without assigning the new virtual machine instances to availability zones. Healthy availability zones can be marked accordingly. For each virtual machine instance to be deleted, the virtual machine instance is deleted from the corresponding availability zone in which the virtual machine is allocated to and a new virtual machine is allocated to a healthy availability zone. Allocating a virtual machine to a healthy availability zone is based on determining first whether the healthy availability zone has capacity, and second, comparatively to other healthy availability zones, whether the availability zone has the fewest virtual machines and marked as available to be allocated new virtual machines. Allocating the new virtual machine instance to a healthy availability zone can further be based on determining an allocation configuration score for allocating the new virtual machine instance to the availability zone.

The availability zones are then rebalanced. Rebalancing the availability zones can further be based on determining whether the virtual machine instance count in an availability zone is less than an average for availability zones. When the virtual machine instance count is less than the average, an action is taken to create new virtual machines in availability zones to catch up to the virtual machine instance count. The number of new virtual machines created in a less than average availability zone can be deleted from an availability zone with the most virtual machine instances that have failed.

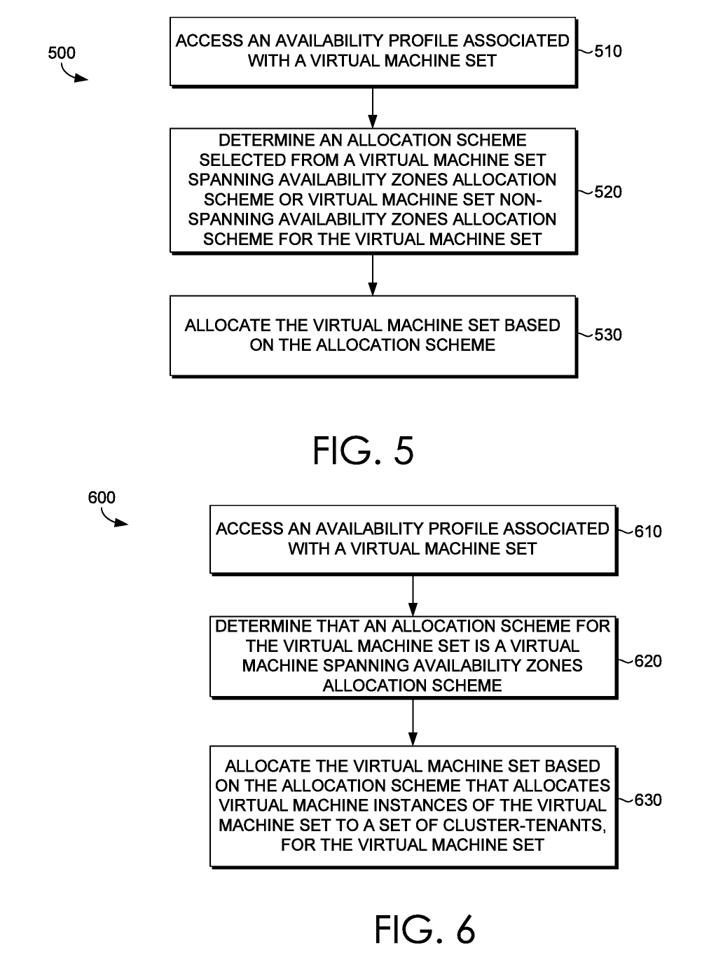

Turning now to FIG. 5, a flow diagram is provided that illustrates a method 500 for implementing availability management in distributed computing systems. The method 500 can be performed using the availability management system described herein. Initially at block 510, an availability profile is accessed. The availability profile comprises availability parameters for allocating a virtual machine set. The availability parameters can include two or more availability isolation tiers corresponding to a plurality of availability zones, a plurality of fault domains and a plurality of update domains. The availability parameters are selected based on logically-defined availability zones that are mapped to physically-defined availability zones. The logically-defined availability zones abstract the allocation of virtual machine sets to the physically-defined availability zones.

At block 520, an allocation scheme is determined for the virtual machine set, based on the availability profile. The allocation scheme indicates how to allocate the virtual machine set to computing clusters. The allocation scheme is selected from one of: a virtual machine set spanning availability zones allocation scheme and virtual machine set non-spanning availability zones allocation scheme, the virtual machine spanning availability zones allocation scheme for allocating the virtual machine set comprises performing evaluations to determine a spanned allocation configuration defined across at least two availability zones. The spanned allocation configuration meets the availability parameters of the availability profile. The virtual machine non-spanning availability zones allocation scheme for allocating the virtual machine set comprises performing evaluations to determine a non-spanned allocation configuration defined for one availability zone. The non-spanned allocation configuration meets the availability parameters of the availability profile. It is further contemplated that based on the availability parameters selected by a tenant, the non-spanning availability zones allocation scheme further indicates that the non-spanning allocation configuration should be limited to one cluster-tenant of a computing cluster in the one availability zone such that availability guarantees are precisely defined for the plurality of fault domains and a plurality of upgrade domains of the one cluster-tenant.

An allocation scheme determines an allocation configuration score for different allocation configurations for the virtual machine set in the availability zones such that the allocation configuration of the virtual machine set is selected based on the allocation configuration score. For example, allocation configuration scores for different allocation configurations can be compared, with the allocation configuration associated with best allocation configuration score used as the allocation configuration for the virtual machine set. The allocation configuration score is determined based on a current virtual machine instance count of a cluster-tenant, a remaining virtual machine instance to be allocated count and a maximum supported virtual machine count of the cluster-tenant.

At block 530, the virtual machine set is allocated based on the allocation scheme. Allocating the virtual machine set includes allocating the virtual machine set across the plurality of availability zones, the plurality of fault domains, and the plurality of update domains. An update domain defines an update-tier isolated point of failure relative to the fault-tier and the zone-tier. The plurality of fault domains and the plurality of update domains for the virtual machine set are logically-defined based on a mapping to underlying physical hardware.

Allocating the virtual machine set includes allocating virtual machine instances to availability zones having a least number of virtual machine instances count. Cluster-tenants are configured with a maximum virtual machine instance count limit such that virtual machine instances of the virtual machine set are allocated to the cluster-tenants instantiated on the plurality of computing clusters across the at least two availability zones.

Turning now to FIG. 6, a flow diagram is provided that illustrates a method 600 for implementing availability management in distributed computing systems. The method 600 can be performed using the availability management system described herein. In particular, one or more computer storage media having computer-executable instructions embodied thereon that, when executed, by one or more processors, can cause the one or more processors to perform the method 600. Initially at block 610, an availability profile is accessed. The availability profile includes availability parameters for allocating a virtual machine set, where the availability parameters comprise at least two availability isolation tiers corresponding to a plurality of availability zones and a plurality of fault domains.

At block 620, an allocation scheme is determined for the virtual machine set based on the availability profile. The allocation scheme indicates how to allocate the virtual machine set to computing clusters. The allocation scheme is a virtual machine spanning availability zones allocation scheme for allocating the virtual machine set, the virtual machine spanning availability zones allocation scheme comprises performing evaluations to determine a spanning allocation configuration defined across at least two availability zones. The spanned allocation configuration meets availability zone and fault domain availability parameters of the availability profile.

At block 630, the virtual machine set is allocated based on the allocation scheme. The allocation scheme allocates virtual machine instances of the virtual machine set to a set of cluster-tenants, for the virtual machine set, instantiated on a plurality of computing clusters across the at least two availability zones. The plurality of computing clusters are each independently managed, using a corresponding cluster manager. The cluster manger, for the first virtual machine set, manages a subset of a first set of cluster-tenants in a corresponding computing cluster of the cluster manager, the first set of cluster-tenants are instantiated across the at least two availability zones. And, the cluster manager, for a second virtual machine set, manages a second set of cluster-tenants in the corresponding computing cluster of the cluster manager, the second set of cluster-tenants are instantiated in only one of the at least two availability zones.

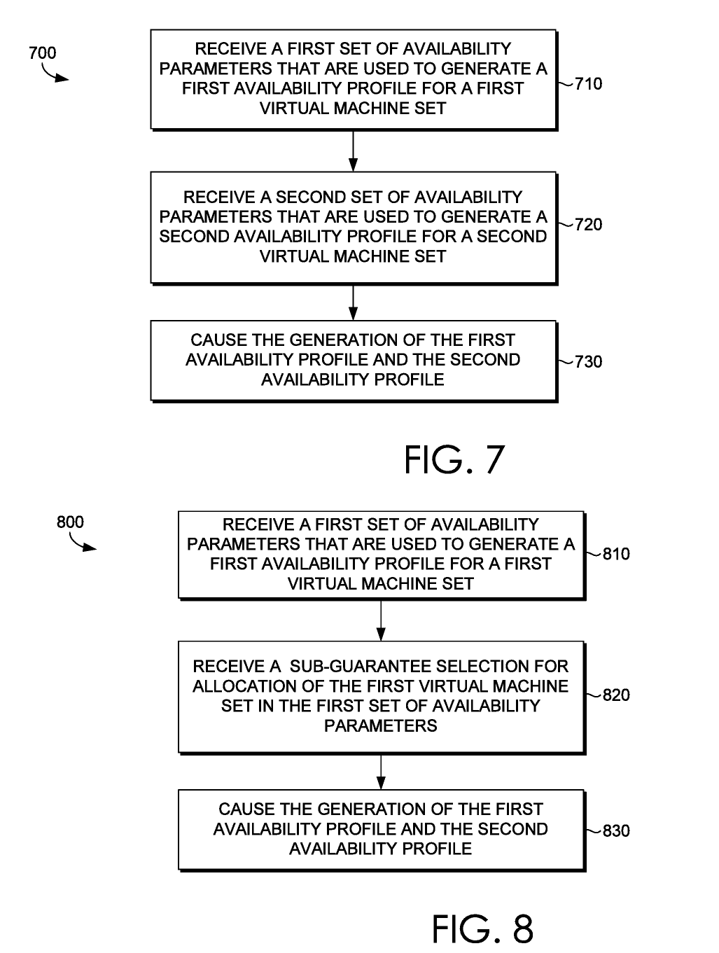

Turning now to FIG. 7, a flow diagram is provided that illustrates a method 700 for implementing availability management in distributed computing systems. The method 700 can be performed using the availability management system described herein. Initially at block 710, a first set of availability parameters that are used to generate a first availability profile for a first virtual machine set is received. The first set of availability parameters include a virtual machine spanning availability zones allocation scheme and two or more availability isolation tiers for allocating the first virtual machine set, the two or more availability isolation tiers based at least on a plurality of availability zones and a plurality of fault domains. The virtual machine spanning availability zones allocation scheme for allocating the first virtual machine set comprises performing evaluations to determine a spanning allocation configuration defined across at least two availability zones. The spanning allocation configuration meets the first set of availability parameters of the first availability profile.

At block 720, a second set of availability parameters that are used to generate a second availability profile for a second virtual machine set is received. The second set of availability parameters include a virtual machine non-spanning availability zones allocation scheme and two or more availability isolation tiers for allocating the second virtual machine set, the two or more availability isolation tiers based at least on the plurality of availability zones and the plurality of fault domains. The virtual machine non-spanning availability zones allocation scheme for allocating the virtual machine set comprises performing evaluations to determine a non-spanning allocation configuration defined for one availability zone. The non-spanning allocation configuration meets the second set of availability parameters of the second availability profile.

At block 730, the first availability profile and the second availability profile are caused to be generated based on the corresponding first set of availability parameters and second set of availability parameters. The first availability profile is associated with the first virtual machine set and the second availability profile is associated with the second virtual machine set. The first set of availability parameters and the second set of availability parameters are received via an availability configuration interface. The availability configuration interface is further configured to provide selectable sub-guarantees for allocation of virtual machine sets. The sub-guarantees are implemented based on soft-allocations of virtual machine sets via the logically-defined availability zones that are unevenly-mapped to the physically-defined availability zones. The availability configuration interface is also configured to receive query for allocation configurations of virtual machines sets and generate visual representations of the allocation configurations of virtual machine sets.

Turning now to FIG. 8, a flow diagram is provided that illustrates a method 800 for implementing availability management in distributed computing systems. The method 800 can be performed using the availability management system described herein. In particular, one or more computer storage media having computer-executable instructions embodied thereon that, when executed, by one or more processors, can cause the one or more processors to perform the method 800. Initially at block 810, a first set of availability parameters that are used to generate a first availability profile for a first virtual machine set is received. The first set of availability parameters include a virtual machine spanning availability zones allocation scheme and two or more availability isolation tiers for allocating the first virtual machine set, the two or more availability isolation tiers based at least on a plurality of availability zones and a plurality of fault domains. The virtual machine spanning availability zones allocation scheme for allocating the first virtual machine set comprises performing evaluations to determine a spanning allocation configuration defined across at least two availability zones. The spanning allocation configuration meets the first set of availability parameters of the first availability profile.

At block 820, a sub-guarantee selection for allocation of the first virtual machine set is identified in the first set of availability parameters. Sub-guarantees are implemented based on soft-allocations of virtual machine sets via logically-defined availability zones that are unevenly-mapped to a physically-defined availability zones. The logically-defined availability zones that are mapped to physically-defined availability zones abstract allocation of virtual machine sets to the physically-defined availability zones. At block 830, an availability profile based on the availability parameters and the sub-guarantee selection is caused to be generated. The availability profile is associated with the virtual machine set.

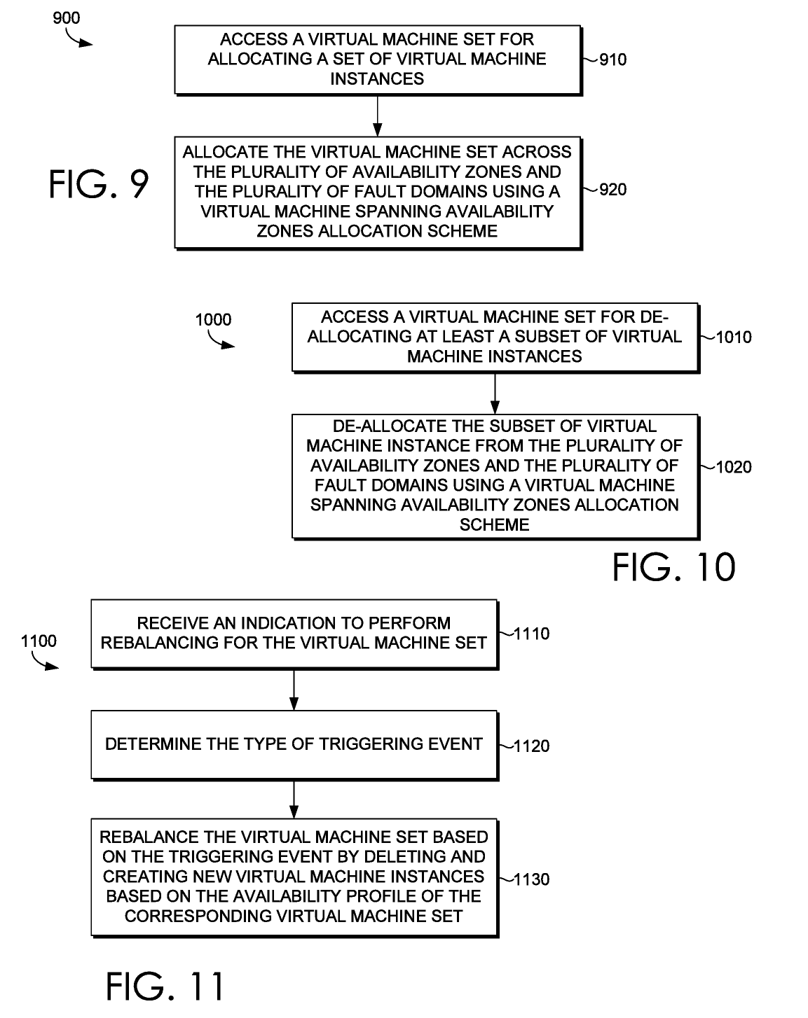

Turning now to FIG. 9, a flow diagram is provided that illustrates a method 900 for implementing availability management in distributed computing systems. The method 900 can be performed using the availability management system described herein. In particular, one or more computer storage media having computer-executable instructions embodied thereon that, when executed, by one or more processors, can cause the one or more processors to perform the method 900.

Initially at block 910, a virtual machine set is accessed. The virtual machine set is associated an availability profile for allocating a set of virtual machine instances associated with a virtual machine set in a plurality of availability zones and a plurality of fault domains.

At block 920, the virtual machine set is allocated across the plurality of availability zones and the plurality of fault domains using a virtual machine spanning availability zones allocation scheme. The virtual machine spanning scheme for allocating the virtual machine set comprises performing evaluations to determine a spanned allocation configuration defined across at least two availability zones. The allocation configuration meets availability zone and fault domain availability parameters in the availability profile. Allocating the virtual machine sets is based on a two-pass sort and filter and bucketing scheme for identifying a subset of computing clusters to prioritize for performing scaling-out operations.

Turning now to FIG. 10, a flow diagram is provided that illustrates a method 1000 for implementing availability management in distributed computing systems. The method 1000 can be performed using the availability management system described herein.

Initially at block 1010, a virtual machine set is accessed. The virtual machine set is associated with an availability profile for de-allocating at least a subset of virtual machine instances of the virtual machine set from a plurality of availability zones and a plurality of fault domains.

At block 1020, the subset of virtual machine instances is de-allocated from the plurality of availability zones and the plurality of fault domains using the virtual machine spanning availability zones allocation scheme. The virtual machine spanning scheme for de-allocating the virtual machine set comprises performing evaluations to determine a spanned de-allocation configuration defined across at least two availability zones. The allocation configuration meets availability zone and fault domain availability parameters in the availability profile. De-allocating the virtual machine set further comprises traversing cluster-tenant, fault domain and update domain pairs to delete a virtual machine instance from a selected cluster-tenant, fault domain and update domain pair having a maximum virtual machine instance count.

Traversing the cluster-tenant, fault domain and update domain pairs comprises determining a virtual machine instance count in each cluster-tenant, fault domain and update domain pair; and deleting one or more virtual machines from a cluster-tenant, fault domain and update domain pair that has the maximum virtual machine instance count. Traversing the cluster-tenant, fault domain and update domain pairs can also be based on determining that a virtual machine count for cluster-tenant, fault domain and update domain pair is greater than virtual machine count to be deleted, selecting a fault domain with a maximum virtual machine instance count for fault domains. In the fault domain, selecting an update domain with a maximum supported virtual machine count for update domains and deleting a virtual machine instance from the update domain. In embodiments, de-allocating the virtual machine set is based at least in part on determining a rebalancing cost for cluster-tenants, the rebalancing cost is a measure of the shortest path to balanced cluster-tenants.

Turning now to FIG. 11, a flow diagram is provided that illustrates a method 1100 for implementing availability management in distributed computing systems. The method 1100 can be performed using the availability management system described herein. Initially at block 1110, an indication to perform rebalancing for the virtual machine set is received. The indication is received based on an occurrence of a triggering event. At block 1120, a determination is made of the type of triggering event, where the type of trigger event indicates how to rebalance the virtual machine set in computing clusters. At block 1130, the virtual machine set is rebalanced based on the type of trigger event. Rebalancing the virtual machine set comprises deleting and creating new virtual machine instances based on the availability profile of the corresponding virtual machine set.

With reference to the availability management system, embodiments described herein support supports customizable, hierarchical and flexible availability configurations to maximize utilization of computing resources in a distributed computing system to meet availability guarantees for tenant infrastructure (e.g., customer virtual machine sets). The availability management system components refer to integrated components for availability management. The integrated components refer to the hardware architecture and software framework that support availability management functionality using the availability management system. The hardware architecture refers to physical components and interrelationships thereof and the software framework refers to software providing functionality that can be implemented with hardware embodied on a device. The end-to-end software-based availability management system can operate within the availability management system components to operate computer hardware to provide availability management system functionality. As such, the availability management system components can manage resources and provide services for the availability management system functionality. Any other variations and combinations thereof are contemplated with embodiments of the present invention.

By way of example, the availability management system can include an API library that includes specifications for routines, data structures, object classes, and variables may support the interaction between the hardware architecture of the device and the software framework of the availability management system. These APIs include configuration specifications for the availability management system such that the different components therein can communicate with each other in the availability management system, as described herein.

Having briefly described an overview of embodiments of the present invention, an exemplary operating environment in which embodiments of the present invention may be implemented is described below in order to provide a general context for various aspects of the present invention. Referring initially to FIG. 12 in particular, an exemplary operating environment for implementing embodiments of the present invention is shown and designated generally as computing device 1200. Computing device 1200 is but one example of a suitable computing environment and is not intended to suggest any limitation as to the scope of use or functionality of the invention. Neither should the computing device 1200 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 12, computing device 1200 includes a bus 1210 that directly or indirectly couples the following devices: memory 1212, one or more processors 1214, one or more presentation components 1216, input/output ports 1218, input/output components 1220, and an illustrative power supply 1222. Bus 1210 represents what may be one or more busses (such as an address bus, data bus, or combination thereof). Although the various blocks of FIG. 12 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 12 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 12 and reference to “computing device.”

Computing device 1200 typically includes a variety of computer-readable media. Computer-readable media can be any available media that can be accessed by computing device 1200 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1200. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1212 includes computer storage media in the form of volatile and/or nonvolatile memory. The memory may be removable, non-removable, or a combination thereof. Exemplary hardware devices include solid-state memory, hard drives, optical-disc drives, etc. Computing device 1200 includes one or more processors that read data from various entities such as memory 1212 or I/O components 1220. Presentation component(s) 1216 present data indications to a user or other device. Exemplary presentation components include a display device, speaker, printing component, vibrating component, etc.

I/O ports 1218 allow computing device 1200 to be logically coupled to other devices including I/O components 1220, some of which may be built in. Illustrative components include a microphone, joystick, game pad, satellite dish, scanner, printer, wireless device, etc.

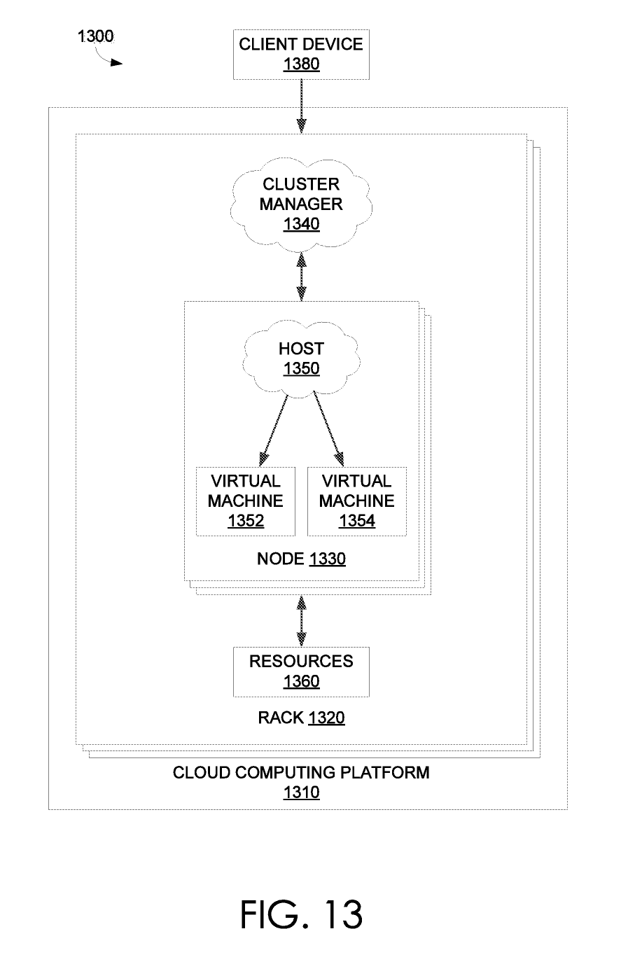

Referring now to FIG. 13, FIG. 13 illustrates an exemplary distributed computing environment 1300 in which implementations of the present disclosure may be employed. In particular, FIG. 13 shows a high level architecture of the availability management system (“system”) in a cloud computing platform 1310, where the system supports seamless modification of software component. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Data centers can support the distributed computing environment 1300 that includes the cloud computing platform 1310, rack 1320, and node 1330 (e.g., computing devices, processing units, or blades) in rack 1320. The system can be implemented with a cloud computing platform 1310 that runs cloud services across different data centers and geographic regions. The cloud computing platform 1310 can implement a cluster manager 1340 component for provisioning and managing resource allocation, deployment, upgrade, and management of cloud services. Typically, the cloud computing platform 1310 acts to store data or run service applications in a distributed manner. The cloud computing infrastructure 1310 in a data center can be configured to host and support operation of endpoints of a particular service application. The cloud computing infrastructure 1310 may be a public cloud, a private cloud, or a dedicated cloud.

The node 1330 can be provisioned with a host 1350 (e.g., operating system or runtime environment) running a defined software stack on the node 1330. Node 1330 can also be configured to perform specialized functionality (e.g., compute nodes or storage nodes) within the cloud computing platform 1310. The node 1330 is allocated to run one or more portions of a service application of a tenant. A tenant can refer to a customer utilizing resources of the cloud computing platform 1310. Service application components of the cloud computing platform 1310 that support a particular tenant can be referred to as a tenant infrastructure or tenancy. The terms service application, application, or service are used interchangeably herein and broadly refer to any software, or portions of software, that run on top of, or access storage and compute device locations within, a datacenter.

When more than one separate service application is being supported by the nodes 1330, the nodes may be partitioned into virtual machines (e.g., virtual machine 1352 and virtual machine 1354). Physical machines can also concurrently run separate service applications. The virtual machines or physical machines can be configured as individualized computing environments that are supported by resources 1360 (e.g., hardware resources and software resources) in the cloud computing platform 1310. It is contemplated that resources can be configured for specific service applications. Further, each service application may be divided into functional portions such that each functional portion is able to run on a separate virtual machine. In the cloud computing platform 1310, multiple servers may be used to run service applications and perform data storage operations in a cluster. In particular, the servers may perform data operations independently but exposed as a single device referred to as a cluster. Each server in the cluster can be implemented as a node.

Client device 1380 may be linked to a service application in the cloud computing platform 1310. The client device 1380 may be any type of computing device, which may correspond to computing device 1300 described with reference to FIG. 13, for example. The client device 1380 can be configured to issue commands to cloud computing platform 1310. In embodiments, client device 1380 may communicate with service applications through a virtual Internet Protocol (IP) and load balancer or other means that directs communication requests to designated endpoints in the cloud computing platform 1310. The components of cloud computing platform 1310 may communicate with each other over a network (not shown), which may include, without limitation, one or more local area networks (LANs) and/or wide area networks (WANs).

Having described various aspects of the distributed computing environment 1300 and cloud computing platform 1310, it is noted that any number of components may be employed to achieve the desired functionality within the scope of the present disclosure. Although the various components of FIG. 13 are shown with lines for the sake of clarity, in reality, delineating various components is not so clear, and metaphorically, the lines may more accurately be grey or fuzzy. Further, although some components of FIG. 13 are depicted as single components, the depictions are exemplary in nature and in number and are not to be construed as limiting for all implementations of the present disclosure.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the availability management system and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

The invention claimed is:

1. A system for implementing availability management in distributed computing systems, the system comprising:
a plurality of availability zones, wherein an availability zone is a zone-tier isolated point of failure computing constructing with a low-latency to one or more other availability zones;
a plurality of computing clusters, wherein the one or more computing clusters are defined within a corresponding availability zone;
a plurality of fault domains associated with the plurality of computing clusters, wherein a fault domain defines a fault-tier isolated point of failure computing construct;
an availability configuration interface to:
generate an availability configuration interface for receiving availability parameters that are used to generate an availability profile, wherein the availability parameters include an allocation scheme and two or more availability isolation tiers for allocating a virtual machine set, the two or more availability isolation tiers based at least on the plurality of availability zones and the plurality of fault domains; and
cause the generation of the availability profile based on the availability parameters, wherein the availability profile is associated with the virtual machine set.

2. The system of claim 1, further comprising:
an availability manager configured to:
based on the availability profile comprising the availability parameters for allocating the virtual machine set,
allocate the virtual machine set across the plurality of availability zones and the plurality of fault domains using a virtual machine spanning availability zones allocation scheme, wherein the virtual machine spanning scheme for allocating the virtual machine set comprises performing evaluations to determine a spanned allocation configuration defined across at least two availability zones, wherein the spanned allocation configuration meets availability zone and fault domain availability parameters in the availability profile.

3. The system of claim 1, wherein the plurality of computing clusters are each independently managed using a corresponding cluster manager,
wherein the cluster manger, for the first virtual machine set, manages a subset of a first set of cluster-tenants in a corresponding computing cluster of the cluster manager, the first set of cluster-tenants are instantiated across the at least two availability zones, and
wherein the cluster manager, for a second virtual machine set, manages a second set of cluster-tenants in the corresponding computing cluster of the cluster manager, the second set of cluster-tenants are instantiated in only one of the at least two availability zones.

4. The system of claim 1, further comprising the availability manager configured to:
allocate a second virtual machine set on one availability zone and one or more fault domains in the plurality of availability zones and the plurality of fault domains using a virtual machine non-spanning availability zones allocation scheme, wherein the virtual machine non-spanning availability zones allocation scheme for allocating the virtual machine set comprises performing evaluations to determine a non-spanned allocation configuration defined for one availability zone of the at least two availability zones, wherein the allocation configuration meets availability zone and fault domain availability parameters in the availability profile.

5. The system of claim 4, wherein based on the availability parameters, the non-spanning availability zones allocation scheme further indicates that the non-spanning allocation configuration defined should be limited to one cluster-tenant of a computing cluster in the one availability zone such that availability guarantees are precisely defined for the plurality of fault domains and a plurality of upgrade domains of the one cluster-tenant.

6. The system of claim 1, wherein the allocation scheme determines an allocation configuration score for different allocation configurations for the virtual machine set in the availability zones such that the allocation configuration of the virtual machine set is selected based on the allocation configuration score, wherein the allocation configuration score is determined based on a current virtual machine instance count of a cluster-tenant, a remaining virtual machine instance to be allocated count and a maximum supported virtual machine count of the cluster-tenant.

7. The system of claim 1, wherein allocating the virtual machine set comprises allocating the virtual machine set across the plurality of availability zones, the plurality of fault domains, and a plurality of update domains, wherein an update domain defines an update-tier isolated point of failure relative to the fault-tier and the zone-tier.

8. The system of claim 7, wherein the availability configuration interface is further configured to:
provide selectable sub-guarantees for allocation of virtual machine sets, wherein the sub-guarantees are implemented based on soft-allocations of virtual machine sets via the logically-defined availability zones that are unevenly-mapped to the physically-defined availability zones.

9. The system of claim 1, further comprising the availability configuration interface configured to:
receive a query for allocation configurations of virtual machines sets; and
generate visual representations of the allocation configurations of virtual machine sets.

10. A computer-implemented method for implementing availability management in distributed computing systems, the method comprising:
receiving a first set of availability parameters that are used to generate a first availability profile for a first virtual machine set, wherein the first set of availability parameters include a virtual machine spanning availability zones allocation scheme and two or more availability isolation tiers for allocating the first virtual machine set, the two or more availability isolation tiers based at least on a plurality of availability zones and a plurality of fault domains,
wherein the virtual machine spanning availability zones allocation scheme for allocating the first virtual machine set comprises performing evaluations to determine a spanning allocation configuration defined across at least two availability zones, wherein the spanning allocation configuration meets the first set of availability parameters of the first availability profile;
receiving a second set of availability parameters that are used to generate a second availability profile for a second virtual machine set, wherein the second set of availability parameters include a virtual machine non-spanning availability zones allocation scheme and two or more availability isolation tiers for allocating the second virtual machine set, the two or more availability isolation tiers based at least on the plurality of availability zones and the plurality of fault domains,
wherein the virtual machine non-spanning availability zones allocation scheme for allocating the virtual machine set comprises performing evaluations to determine a non-spanning allocation configuration defined for one availability zone, wherein the non-spanning allocation configuration meets the second set of availability parameters of the second availability profile; and
causing the generation of the first availability profile and the second availability profile based on the corresponding first set of availability parameters and second set of availability parameters, wherein the first availability profile is associated with the first virtual machine set and the second availability profile is associated with the second virtual machine set.

11. The method of claim 10, further comprising:
receiving a query for allocation configurations of virtual machines sets; and
generating visual representations of the allocation configurations of virtual machine sets.

12. The method of claim 10, wherein the first set of availability parameters comprises a sub-guarantee selection for allocation of the first virtual machine set, wherein the sub-guarantees are implemented based on soft-allocations of virtual machine sets via logically-defined availability zones that are unevenly-mapped to a physically-defined availability zones, wherein logically-defined availability zones that are mapped to physically-defined availability zones abstract allocation of virtual machine sets to the physically-defined availability zones.

13. The method of claim 10, wherein the plurality of computing clusters are each independently managed using a corresponding cluster manager,
wherein the cluster manger, for the first virtual machine set, manages a subset of a first set of cluster-tenants in a corresponding computing cluster of the cluster manager, the first set of cluster-tenants are instantiated across the at least two availability zones, and
wherein the cluster manager, for a second virtual machine set, manages a second set of cluster-tenants in the corresponding computing cluster of the cluster manager, the second set of cluster-tenants are instantiated in only one of the at least two availability zones.

14. The method of claim 10, wherein allocating the virtual machine set comprises allocating the virtual machine set across the plurality of availability zones, the plurality of fault domains, and a plurality of update domains, wherein an update domain defines an update-tier isolated point of failure relative to the fault-tier and the zone-tier.

15. The method of claim 10, wherein based on the second set of availability parameters, the non-spanning availability zones allocation scheme further indicates that the non-spanning allocation configuration should be limited to one cluster-tenant of a computing cluster in the one availability zone such that availability guarantees are precisely defined for the plurality of fault domains and a plurality of upgrade domains of the one cluster-tenant.

16. One or more computer storage media having computer-executable instructions embodied thereon that, when executed, by one or more processors, causes the one or more processors to perform a method for implementing availability management in distributed computing systems, the method comprising:
receiving a first set of availability parameters that are used to generate a first availability profile for a first virtual machine set, wherein the first set of availability parameters include a virtual machine spanning availability zones allocation scheme and two or more availability isolation tiers for allocating a virtual machine set, the two or more availability isolation tiers based at least on a plurality of availability zones and a plurality of fault domains,
wherein the virtual machine spanning allocation scheme for allocating the virtual machine set comprises performing evaluations to determine a spanning allocation configuration defined across at least two availability zones, wherein the spanning allocation configuration meets the first set of availability parameters of the first availability profile;
receiving a sub-guarantee selection for allocation of the first virtual machine set in the first set of availability parameters, wherein the sub-guarantees are implemented based on soft-allocations of virtual machine sets via logically-defined availability zones that are unevenly-mapped to a physically-defined availability zones, wherein logically-defined availability zones that are mapped to physically-defined availability zones abstract allocation of virtual machine sets to the physically-defined availability zones; and
causing the generation of an availability profile based on the availability parameters comprising the sub-guarantee selection, wherein the availability profile is associated with the virtual machine set.

17. The media of claim 16, further comprising:
receiving a query for allocation configurations of virtual machines sets; and
generating visual representations of the allocation configurations of virtual machine sets.

18. The media of claim 16, wherein the plurality of computing clusters are each independently managed using a corresponding cluster manager,
wherein the cluster manger, for the first virtual machine set, manages a subset of a first set of cluster-tenants in a corresponding computing cluster of the cluster manager, the first set of cluster-tenants are instantiated across the at least two availability zones, and
wherein the cluster manager, for a second virtual machine set, manages a second set of cluster-tenants in the corresponding computing cluster of the cluster manager, the second set of cluster-tenants are instantiated in only one of the at least two availability zones.

19. The media of claim 16, wherein allocating the virtual machine set comprises allocating the virtual machine set across the plurality of availability zones, the plurality of fault domains, and a plurality of update domains, wherein an update domain defines an update-tier isolated point of failure relative to the fault-tier and the zone-tier.

20. The media of claim 19, wherein the plurality of fault domains and the plurality of update domains for the virtual machine set are logically-defined based on a mapping to underlying physical hardware.
